(19) United States
(12) Patent Application Publication
(10) Pub. No.: US 2009/0177722 A1
(43) Pub. Date: Jul. 9, 2009

(54) ARITHMETIC PROCESSING APPARATUS

(75) Inventor: Satomi MIDOROGI, Iruma-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/348,991

(22) Filed: Jan. 6, 2009

(30) Foreign Application Priority Data
Jan. 8, 2008 (JP) 2008-000868

(51) Int. Cl. G06F 15/04

(52) U.S. Cl. 708/130

(57) ABSTRACT

In a graphing scientific electronic calculator 10, when a graphing mode is selected from an application list 12a, a function expression entering screen is displayed on a display unit 16. When an function expression is entered and EXE key 15e is operated, an appropriate graph is drawn in accordance with a re-writing setting 14a when the re-writing setting 14a is stored, or in accordance with initial setting data relating to the graphing mode in an initial setting data table 12c. When a program conversion is instructed, a series of operations including the initial setting condition are converted into a program in accordance with a program conversion program 12d and stored as program data 12e. The program data 12e is performed by arithmetic processing program 12b, thereby the series of operations are re-performed.

### CROSS REFERENCE TO THE RELATED APPLICATION(S)

The present application is based upon and claims priority from prior Japanese Patent Application No. 2008-000868, filed on Jan. 8, 2008, the entire content of which are incorporated herein by reference.

### BACKGROUND OF THE INVENTION

1. Field of the Invention

The present invention relates to an arithmetic processing apparatus.

2. Description of the Related Art

Electronic apparatuses of a compact size such as scientific electronic calculators with various arithmetic processing functions and graphing function are widely in practical use. Particularly in the field of education, the scientific electronic calculators are used by teachers and students in classrooms for lesson in making a calculation of a mathematical expression and drawing a graph.

The scientific electronic calculator has a so-called program function. The program function calls up a character string (hereinafter, a “program”) consisting of a group of instructions and successively performs arithmetic operations corresponding to the instructions, wherein the instructions include an instructions to make a calculation of a mathematical expression and instruction to draw a graph of the mathematical expression. Using the program function, an arithmetic process consisting of plural steps can be performed at a time and stored in a single file. Lessons using the program function are frequently conducted in the classrooms.

With respect to the scientific electronic calculators with various functions, it has been proposed to record the history of a series of operations performed on the calculator. For example, JP 2006-331484 A discloses an apparatus, in which a history of key input operations is registered and a manipulation guide is displayed in accordance with the registered history of key input operations, allowing users to make his or her desired arithmetic calculation without hesitating in manipulating the calculator.

To display the manipulation guide on the scientific electronic calculator in accordance with the registered history of key input operations, the calculator must have a mode specified for that purpose, and the manipulation guide can be displayed only on the calculator having such specified mode. Further, it is hard in conventional calculators to replace an operation out of the registered operations with another one or to add a new operation in the registered operations.

### SUMMARY OF THE INVENTION

The present invention has an object to provide an arithmetic processing apparatus which produces a program for re-performing a series of operations previously performed by a user, and allows another scientific electronic calculators with a program function to use such program, whereby the series of operations previously performed in the present arithmetic processing apparatus can be re-performed in another scientific electronic calculators.

According to one aspect of the invention, there is provided an arithmetic processing apparatus which comprises an arithmetic processing unit for carrying out an arithmetic process in response to operation of a user, a character string producing unit for producing a character string including plural instructions, wherein the plural instructions signify performance of a series of arithmetic processes carried out by the arithmetic processing unit, a character string storing unit for storing the character string produced by the character string producing unit, and a character string reading unit for reading the character string from the character string storing unit, and for, when the read character string includes an instruction signifying performance of a predetermine arithmetic process, making the arithmetic processing unit carry out the predetermined arithmetic process corresponding to the instruction.

### BRIEF DESCRIPTION OF THE DRAWINGS

FIG. 1 is a block diagram of an electronic circuit of a graphing scientific electronic calculator 10 according to embodiments of an arithmetic processing apparatus of the present invention.

FIG. 2 is a view showing an initial setting data table 12c stored in a recording area 12 of the graphing scientific electronic calculator 10.

FIG. 3 is a flow chart (#1) of a graphing process in a graphing mode of the graphing scientific electronic calculator 10.

FIG. 4 is a flow chart (#2) of a program converting process in the graphing mode of the graphing scientific electronic calculator 10.

FIG. 5A to FIG. 5T are views illustrating display screens displayed on a display unit 16 in response to key operation in the program converting process in the graphing mode of the graphing scientific electronic calculator 10.

### PREFERRED EMBODIMENTS OF THE INVENTION

Embodiments of the present invention will be described in detail with reference to the accompanying drawings. The scope of the claimed invention should not be limited to the examples illustrated in the drawings.

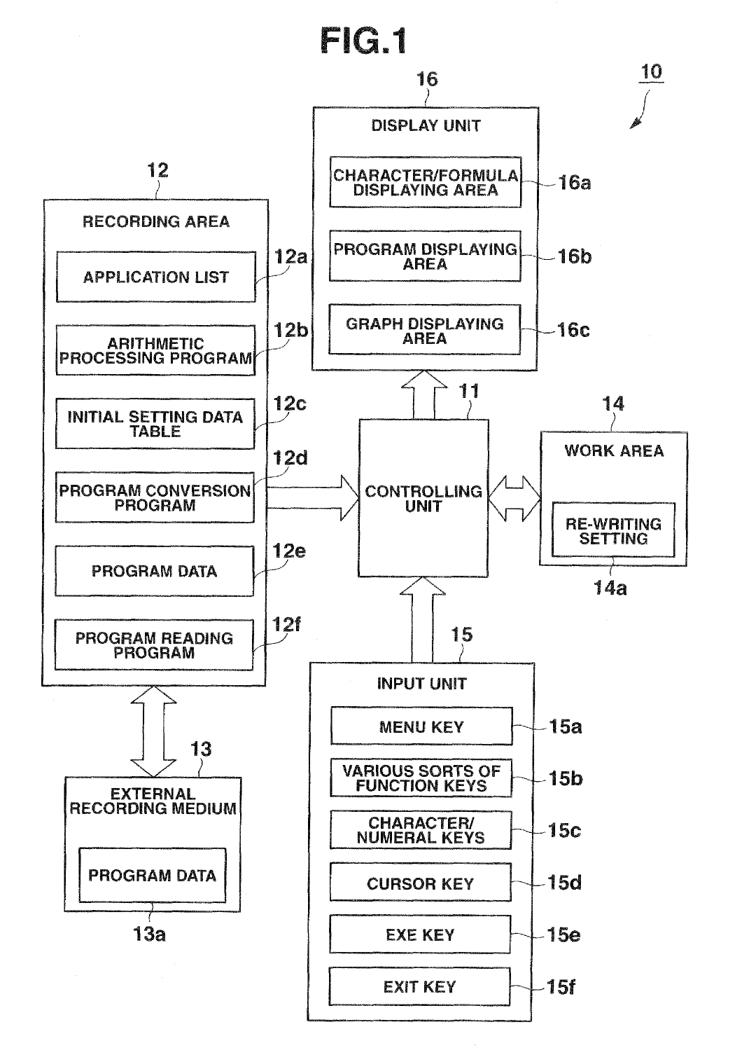

FIG. 1 is a block diagram illustrating an electronic circuit configuration of a graphing scientific electronic calculator 10 (hereinafter, simply referred to as “graphing electronic calculator”) according to an embodiment of the arithmetic processing apparatus of the present invention. The graphing electronic calculator 10 has a control unit (CPU) 11 including a computer.

The control unit 11 activates a system program previously stored in a recording area 12 of a flash ROM in accordance with input data entered from an input unit 15, and controls operations of various circuits, using a work memory of RAM as a work area 14, or the control unit 11 reads a system control program previously stored in an external recording medium 13 such as a memory card and/or a personal computer connected thereto, and stores and activates the read program in the recording area 12, thereby controlling the operations of the various circuits of the graphing electronic calculator 10.

The control unit 11 is connected with the input unit 15, recording area 12, work area 14, and a display unit 16.

Various displaying areas are displayed on the display unit 16 according to need, wherein the various displaying areas include a character/formula displaying area 16a, program displaying area 16b, and graph displaying area 16c corresponding to various sorts of arithmetic processes respectively.

In the recording area 12 is previously stored the system program for controlling the whole operations of the electronic circuits in the graphing electronic calculator 10. Further, in the recording area 12 are stored an application list 12a, an arithmetic processing program 12b, an initial setting data table 12c, a program conversion program 12d, program data 12e, and a program reading program 12f. The application list 12a indicates programs which can be arithmetically processed in the present graphing electronic calculator 10, and the arithmetic processing program 12b performs various arithmetic processes corresponding to applications in a graphing mode and a program editing mode. The initial setting data table 12c is used as initial values of setting data for performing various arithmetic processes to be performed by the arithmetic processing program 12b. The program conversion program 12d converts into programs contents of the arithmetic processes performed by the arithmetic processing program 12b, the program data 12e records the programs converted by the program conversion program 12d and a program produced by a user, and the program reading program 12f reads the program data 12e to be performed by the arithmetic processing program 12b.

The external recording medium 13 is capable of exchanging data with the recording area 12 of the graphing electronic calculator 10. For instance, the external recording medium 13 reads the program data 12e from the recording area 12 and stores the data 12e therein as program data 13a, thereby allowing other graphing electronic calculators and computers to use or perform program data 12e produced in the present graphing electronic calculator 10. Further, the external recording medium 13 stores the program data 13a in the recording area 12 of the present graphing electronic calculator 10 as program data 12e, thereby allowing the graphing electronic calculator 10 to perform the program data produced by other graphing electronic calculators and computers.

The input unit 15 includes a menu key 15a, various sorts of function keys 15b, character/numeral keys 15c, a cursor key 15d, EXE key 15e, and EXIT key 15f.

The menu key 15a is used to read the application list 12a stored in the recording area 12 to display the read application list 12a on the display unit 16.

The function key 15b is used to read from the arithmetic processing program 12b stored in the recording area 12 an arithmetic process corresponding to an application while said application is being performed.

The character/numeral keys 15c include a group of keys for entering symbols, characters and numerals, and are used to enter the user's desired arithmetic expression, function expression and/or character string.

The cursor key 15d is used to move a cursor, to choose an item out of plural items and/or to move a graph displaying area, wherein the cursor, items and graph displaying area are displayed on a display screen of the display unit 16.

The EXE key 15e is used to decide data which is entered by the user's operation.

The EXIT key 15f is used to close a display screen in use to return to a prior display screen.

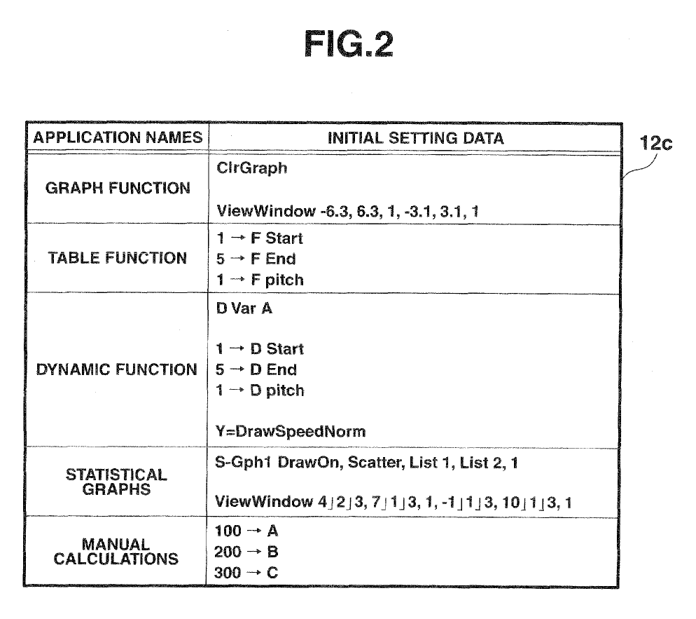

FIG. 2 is a view illustrating an example of the initial setting data table 12c stored in the recording area 12 of the graphing electronic calculator 10.

In the initial setting data table 12c are stored names of the applications in the application list 12a stored in the recording area 12 and the initial data which are associated with the applications respectively. For example, an application name “Graph Function” (the graphing mode) is associated with “CirGraph” and “ViewWindow −6.3,6.3,1, −3.1,3.1,1”.

When a graph is drew in the graphing mode, the former “ClrGraph” means to clear or delete the graph which is already drawn. Unless otherwise specified, the latter means to draw a graph under the initial condition where x-axis is marked with a scale every one step within the range of −6.3<X<6.3 and y-axis is marked with a scale every one step within the range of −3.1<Y<3.1.

In FIG. 2, the initial setting data is written in a character string format which can be read by the program reading program 12f stored in the recording area 12. The initial setting data is not restricted to one in the character string format, and the user is allowed to re-write and store the initial setting data in another format.

Taking one operation as an example, the program converting process to be performed in the graphing electronic calculator 10 having the configuration set forth above will be described.

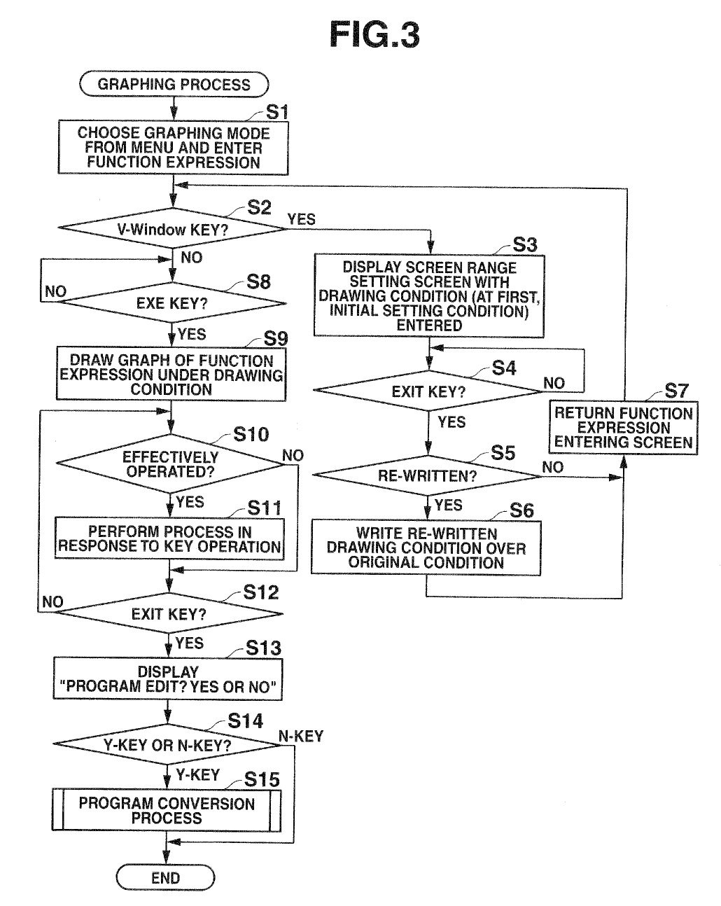

FIG. 3 is a flow chart showing a graphing process (#1) in the graphing mode of the graphing electronic calculator 10.

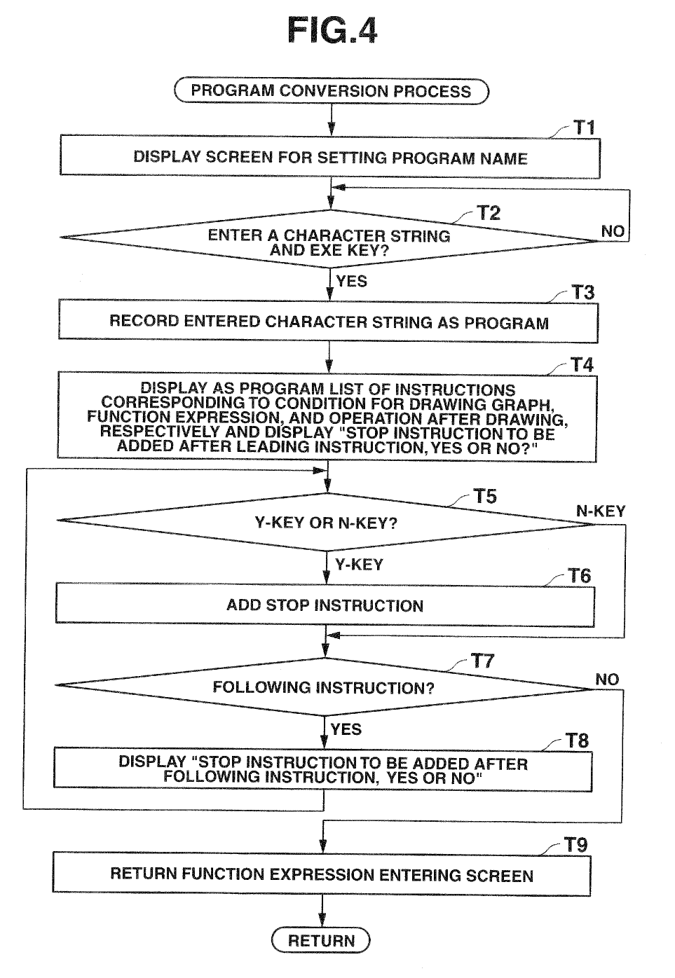

FIG. 4 is a flow chart showing a program converting process (#2) in the graphing mode of the graphing electronic calculator 10.

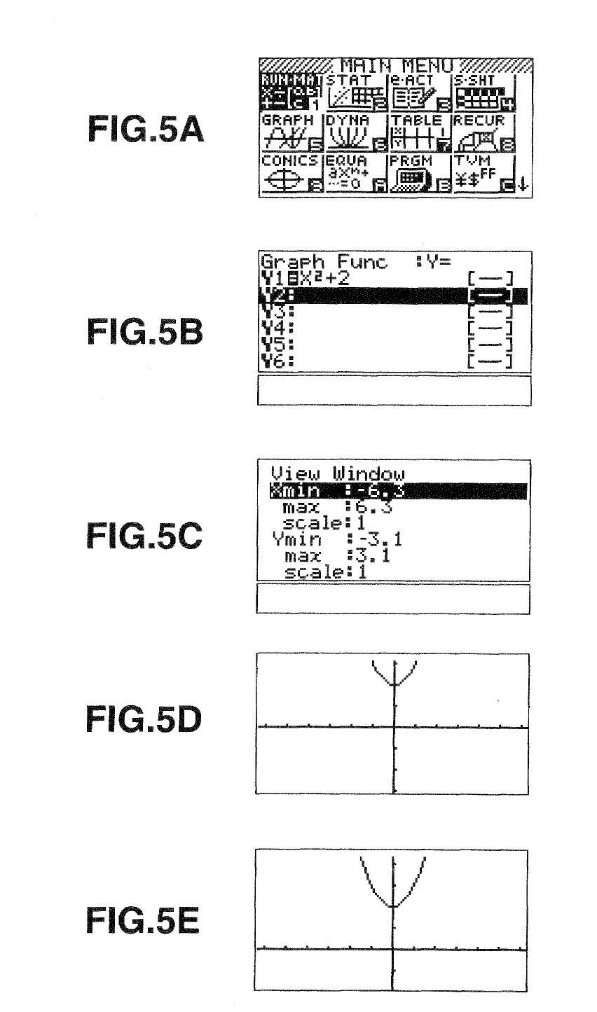

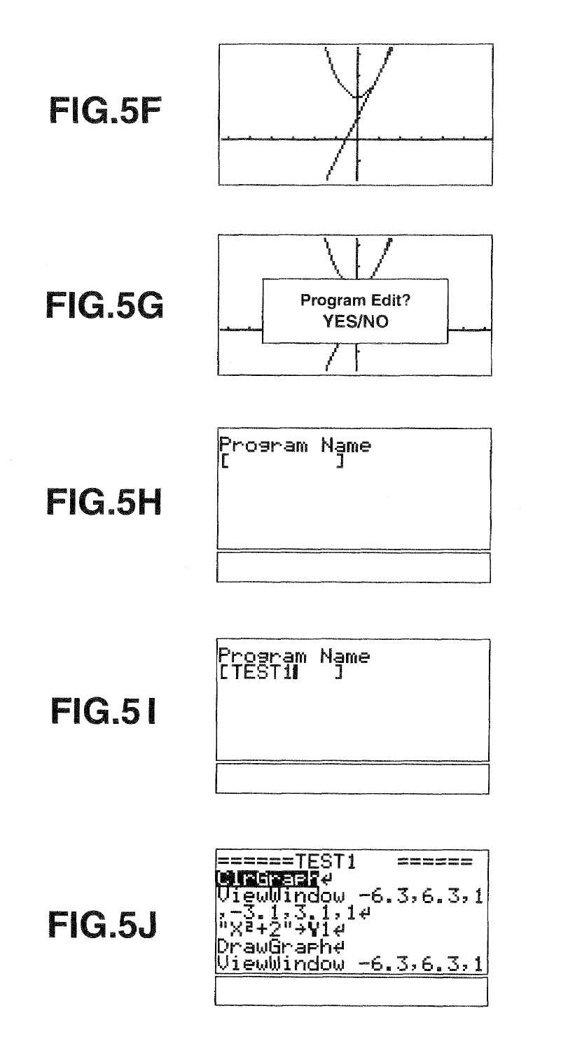

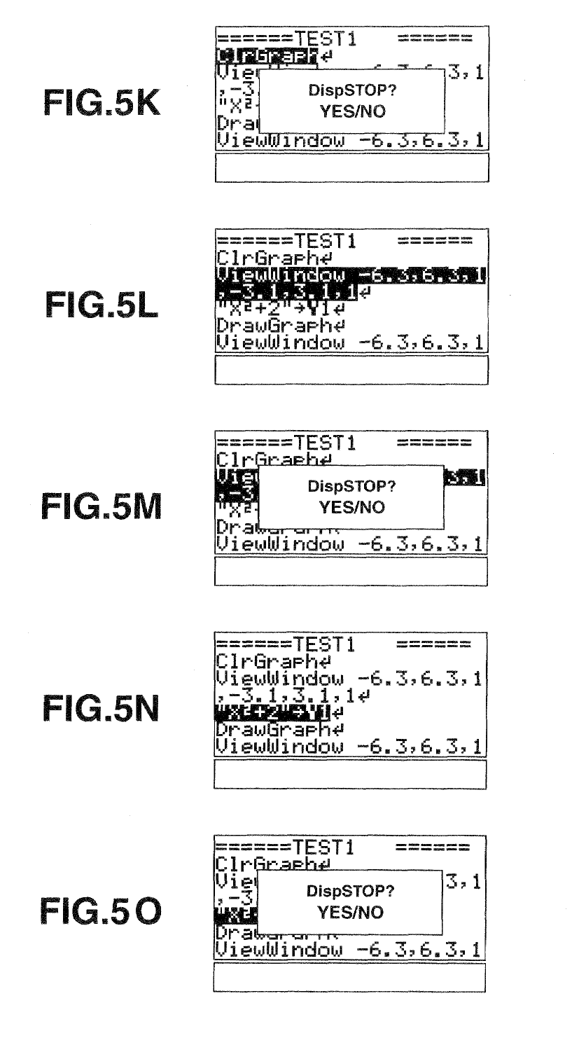

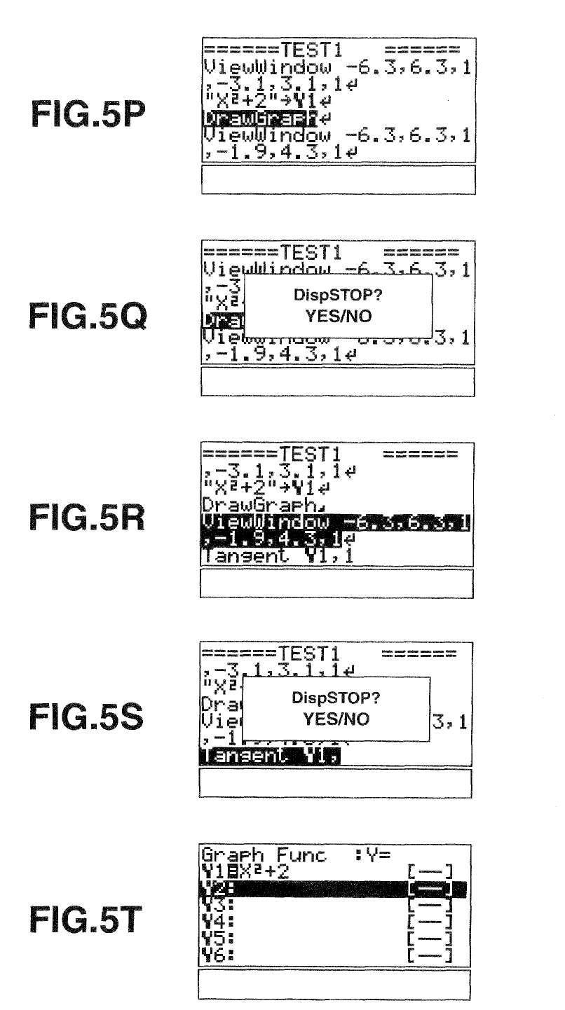

FIG. 5A to FIG. 5T are views illustrating operating states displayed on the display unit 16 in the program converting process in the graphing mode of the graphing electronic calculator 10.

FIG. 5A is a view illustrating a menu screen displayed on the display unit 16, wherein the menu screen includes a list of icons corresponding to applications in the application list 12a, which is read from the recording area 12 in response to operation performed on the menu key 15a.

With the menu screen displayed on the display unit 16, an icon choosing display is changed to an icon with “GRAPH” indicated in response to operation of the cursor key 15d, and the graphing mode is activated in response to operation of EXE key 15e, and a function expression entering screen of the graphing mode is displayed on the display unit 16 together with the character/formula displaying area 16a. When an function expression of “(Y1=)X²+2” is entered in response to operation of the character/numeral keys 15c, a display screen is displayed on the display unit 16 as shown in FIG. 5B (step S1 in FIG. 3).

When a screen of “ViewWindow” is called up in response to operation of V-Window key 15b1 (not shown) in the function keys 15b, a drawing condition, that is, data of “ViewWindow −6.3,6.3,1, −3.1,3.1,1” is read from the initial setting data table 12c, and a screen range setting screen is displayed on the display unit 16 with said data entered as a graphing condition as shown in FIG. 5C, wherein said data of “ViewWindow −6.3,6.3,1, −3.1,3.1,1” is included in the initial setting data corresponding to the activated graphing mode (Graph Function). More specifically, the screen range setting screen indicates that x-axis is marked with a scale every one step within the range of −6.3<X<6.3 and y-axis is marked with a scale every one step within the range of −3.1<Y<3.1. The user is allowed to re-write the drawing condition by operating the input unit 15, in particular, by operating the character/numeral keys 15c and/or the cursor key 15d (YES at step S2 to step S3).

It is judged whether or not the graphing condition has been changed in response to operation of the EXE key 15f (YES at step S4 to step S5). When it is determined that the graphing condition has not been changed, the original function expression entering screen is kept displayed on the display unit 16 as shown in FIG. 5B (NO at step S5 to step S7) Meanwhile, when it is determined that the graphing condition has been changed, then the changed graphing condition is stored as a re-writing setting 14a in the work area 14, and the original function expression entering screen is displayed on the display unit 16 (YES at step S5 to step S6 to step S7). Thereafter, when V-Window key 15L1 (not shown) is operated again, the screen of “ViewWindow” is called up again. When the graphing condition is stored in the re-writing setting 14a of the work area 14, the screen range setting screen is displayed in the display unit 16 with data corresponding to said graphing condition entered. When the graphing condition is not stored in the re-writing setting 14a of the work area 14, the screen range setting screen is displayed on the display unit 16 with data corresponding to the drawing condition in the graphing mode entered, wherein said drawing condition is included in the initial setting data stored in the initial setting data table 12c (YES at step S2 to step S3). Since the following processes after step 3 where the screen range setting screen is displayed are performed in the same manner as described above, said following processes will not be described.

Only the setting of the drawing condition has been described above by example. For setting other data, similar processes will be performed by storing in the work area 14 data corresponding to the initial setting data stored in the initial setting data table 12c as the re-writing setting 14a.

In the case where a display screen is displayed on the display unit 16 as shown in FIG. 5B and the EXE key 15e is operated, a graph corresponding to the displayed function expression “Y1=X²+2” is drawn in accordance with data corresponding to the drawing condition, when such drawing condition is stored in the re-writing setting 14a, and the graph corresponding to the displayed function expression “Y1=X²+2” is drawn in accordance with data corresponding to the drawing condition in the graphing mode, when no drawing condition is stored in the re-writing setting 14a, wherein said drawing condition is included in the initial setting data stored in the setting data table 12c.

Since no drawing condition is stored in the re-writing setting 14a, a graph is drawn under the drawing condition in accordance with data corresponding to the drawing condition in the graphing mode and is displayed in the graph displaying area 16c on the display unit 16 as shown in FIG. 5D, wherein said drawing condition in the graphing mode is included in the initial setting data stored in the initial setting data table 12c (NO at step S2 to YES at step S8 to step S9).

Then, various processes are performed in accordance with the arithmetic processing programs 12b in response to operations of the function keys 15b and cursor key 15d in the input unit 15 and the contents of the performed processes are displayed in the graph displaying area 16c on the display unit 16. For example, when the cursor key 15d is operated, the graph is moved in the direction corresponding the cursor operation to be displayed in the graph displaying area 16c as shown in FIG. 5E (YES at step S10 to step Sit).

In response to operations of the function keys 15b and cursor key 15d in the input unit 15, a tangential line tangent to the previously drew graph at a point of x=1 is drawn as shown in FIG. 5F (NO at step S12 to YES at step S10 to step S11). Further, when the EXE key 15 is operated, an indication of “Program Edit? YES/NO” is displayed on the display unit 16 (YES at step S12 to step S13).

In response to an operation of Y-key (“YES” is chosen) in the character/numeral key 15c, it is determined that a series of processes in a graph mode are converted into programs and a screen for entering program names is displayed on the display unit 16 as shown in FIG. 5H (Y-key at step S14 to step T1 in FIG. 4).

When a character string of “TES1” is entered in response to operation of the character/numeral key 15c, the character string of “TEST1” is displayed in a program name input field on the display unit 16 as shown in FIG. 5I. Further, when the EXE key is operated, the character string of “TEST1” is stored as a program name in the work area 14. A series of processes in the graph mode are converted into an appropriate character string (a group of instructions: a program) in accordance with the program converting program 12d as shown in FIG. 5J. The program (a group of instructions) is displayed in the program displaying area 16b on the display unit 16 with the leading instruction “ClrGraph” highlighted. Further, the EXE key 15e is operated, an indication of “DispSTOP? YES/NO” is displayed on the display unit 16 as shown in FIG. 5K (YES at step T2 to step T3 to step T4).

The displayed program includes the initial setting data. When the drawing condition is stored in the re-write setting 14a, the processes are converted into instructions corresponding to the drawing condition stored in the re-write setting 14a. When no drawing condition is stored in the re-write setting 14a, the processes are converted into instructions corresponding to data of the drawing condition in the graphing mode, wherein said drawing condition is included in the initial setting data stored in the initial setting data table 12c.

When N-key (“NO” is chosen) in the character/numeral key 15c is operated, the indication of “DispSTOP/YES/NO” disappears from the screen on the display unit 16 as shown in FIG. 5L. When it is determined that a following instruction is prepared, the following instruction “ViewWindow −6.3,6.3,1, −3.1,3.1,1” is highlighted. Further, in response to operation of the EXE key 15e, the indication of “DispSTOP? YES/NO” is displayed on the display unit 16 as shown in FIG. 5M (N-key at step T5 to YES at step T7 to step T8).

In a similar manner, when N-key (“NO” is chosen) in the character/numeral key 15c is operated, the indication of “DispSTOP/YES/NO” disappears from the screen on the display unit 16 as shown in FIG. 5N. When it is determined that a following instruction is prepared, the following instruction ““X²+2”->Y1” is highlighted. Further, in response to operation of the EXE key 15e, the indication of “DispSTOP? YES/NO” is displayed on the display unit 16 as shown in FIG. 5O (N-key at step 15 to YES at step T7 to step T8) Thereafter, processes are performed in a similar manner to described above, and therefore FIG. 5P and FIG. 5Q will not be described.

When Y-key in the character/numeral key 15c is operated with the indication of FIG. 5Q displayed on the display unit 16, the indication of “DispSTOP? YES/NO” disappears from the screen on the display unit 16 as shown in FIG. 5R, and an instruction of “DrawGraph” highlighted at step 8(P) is added with a stop instruction “A” at the tail. When it is determined that a following instruction is prepared, the following instruction “ViewWindow −6.3,6.3,1, −1.9,4.3,1” is highlighted (Y-key at step T5 to step T6 to YES at step T7 to step T8).

When the program is read by the program reading program 12 and is performed by the arithmetic processing program 12b, the stop instruction “Δ” written in said program serves to suspend performance of an immediate preceding instruction and to resume performance of the following instruction in response to operation of the EXE key 15e.

The processes at steps T5 to T8 are repeatedly performed, and the last instruction “Tangent Y1,1” in the program is highlighted, and the instruction “DispSTOP? YES/NO” is displayed on the display unit 16, as shown in FIG. 5S. When N-key in the character/numeral keys 15c is operated, the instruction “DispSTOP? YES/NO” disappears. When it is determined that a following instruction is not prepared, a program produced in the above processes is stored as program data 12e in the recording area 12 and a function expression entering screen in the graphing mode is displayed on the display unit 16 as shown in FIG. 5T in the same manner as FIG. 5B (N-key at step T5 to NO at step T7 to step T9 to RETURN to END).

The writing process of the stop instruction “Δ” is not limited to the above process. For example, the stop instruction “Δ” may be entered by selecting a desired instruction in response to operation of the cursor key 15d.

In the above embodiment of the present invention, the graphing electronic calculator 10 is described, in which the application is activated in the graphing mode. The invention is not restricted to the graphing mode in the above embodiment, but may be applied to various programs of the graphing electronic calculator 10 to be performed in a mathematical table mode (Table Function) and/or basic calculating mode (Manual Calculation). In these cases, the initial setting data may be used in a similar manner to the graphing mode.

As described above, in the program converting processing of the graphing electronic calculator 10, an application is selected from the application list 12a stored in the graphing electronic calculator 10, and a series of arithmetic processes are performed by the arithmetic processing program 12b in the application and subjected to the program converting process, whereby the series of arithmetic processes and the initial setting data are converted into a program (character string) consisting of a group of reproducible instructions and stored as program data 12e.

The program data 12e produced in the above process is read by the program reading program 12f in a similar manner to an average program written by the user and performed in the arithmetic processing program 12b, whereby a series of processes in the above embodiment can be reproduced. Therefore, a series of processes performed by the student using the present graphing electronic calculator can be reproduced using a frequently used function, that is, a program function without using a special process.

If the stop instruction is included in a program while the program is produced, the stop instruction can suspend performance of the immediate preceding instruction and resume performance of the following instruction in response to operation of EXE key while the program is running.

The present invention provides the arithmetic processing apparatus which allows arithmetic calculators to perform a series of operations that were performed in other arithmetic calculator.

It is to be understood that the present invention is not limited to the specific embodiments described above and that the invention can be embodied with the components modified without departing from the sprit and scope of the invention. The invention can be embodied in various forms according to appropriate combinations of the components disclosed in the embodiments described above. For example, some components may be deleted from all components shown in the embodiments. Further, the components in different embodiments may be used appropriately in combination.

What is claimed is:

1. An arithmetic processing apparatus comprising:
an arithmetic processing unit for carrying out an arithmetic process in response to operation of a user;
a character string producing unit for producing a character string including plural instructions, wherein the plural instructions signify performance of a series of arithmetic processes carried out by the arithmetic processing unit;
it a character string storing unit for storing the character string produced by the character string producing unit; and
a character string reading unit for reading the character string from the character string storing unit, and for, when the read character string includes an instruction signifying performance of a predetermine arithmetic process, making the arithmetic processing unit carry out the predetermined arithmetic process corresponding to the instruction.

2. The arithmetic processing apparatus according to claim 1, further comprising:
a character string input/output unit for outputting the character string stored in the character string storing unit in response to operation of the user, and for inputting to the character string storing unit a character string received externally in response to operation of the user.

3. The arithmetic processing apparatus according to claim 1, further comprising:
an initial setting information storing unit for storing initial setting information, wherein, when the arithmetic processing unit does not carry out an arithmetic process corresponding to the initial setting information stored in the initial setting information storing unit, the character string producing unit reads the initial setting information from the initial setting information storing unit and produces a character string including the plural instructions and an instruction signifying the initial setting information.

4. The arithmetic processing apparatus according to claim 2, further comprising:
an initial setting information storing unit for storing initial setting information, wherein, when the arithmetic processing unit does not carry out an arithmetic process corresponding to the initial setting information stared in the initial setting information storing unit, the character string producing unit reads the initial setting information from the initial setting information storing unit and produces a character string including the plural instructions and an instruction signifying the initial setting information.

5. The arithmetic processing apparatus according to claim 1, further comprising:
a character string editing unit for reading the character string from the character string storing unit in response to operation of the user to edit said character string, and for writing the edited character string over the original character string, wherein the character string reading unit reads from the character string storing unit the edited character string written by the character string editing unit, and when said edited character string includes an instruction signifying performance of a predetermined arithmetic process, the character string reading unit makes the arithmetic processing unit carry out the predetermined arithmetic process corresponding to the instruction.

6. The arithmetic processing apparatus according to claim 2, further comprising:
a character string editing unit for reading the character string from the character string storing unit in response to operation of the user to edit said character string, and for writing the edited character string over the original character string, wherein the character string reading unit reads from the character string storing unit the edited character string written by the character string editing unit, and when said edited character string includes an instruction signifying performance of a predetermined arithmetic process, the character string reading unit makes the arithmetic processing unit carry out the predetermined arithmetic process corresponding to the instruction.

7. The arithmetic processing apparatus according to claim 3, further comprising:
a character string editing unit for reading the character string from the character string storing unit in response to operation of the user to edit said character string, and for writing the edited character string over the original character string, wherein the character string reading unit reads from the character string storing unit the edited character string written by the character string editing unit, and when said edited character string includes an instruction signifying performance of a predetermined arithmetic process, the character string reading unit makes the arithmetic processing unit carry out the predetermined arithmetic process corresponding to the instruction.

8. The arithmetic processing apparatus according to claim 4, further comprising:
a character string editing unit for reading the character string from the character string storing unit in response to operation of the user to edit said character string, and for writing the edited character string over the original character string, wherein the character string reading unit reads from the character string storing unit the edited character string writ-ten by the character string editing unit, and when said edited character string includes an instruction signifying performance of a predetermined arithmetic process, the character string reading unit rakes the arithmetic processing unit carry out the predetermined arithmetic process corresponding to the instruction.

9. The arithmetic processing apparatus according to claim 1, wherein, when producing the character string which includes the plural instructions signifying performance of the series of arithmetic processes carried out by the arithmetic processing unit, the character string, producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

10. The arithmetic processing apparatus according to claim 2, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

11. The arithmetic processing apparatus according to claim 3, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

12. The arithmetic processing apparatus according to claim 4, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

13. The arithmetic processing apparatus according to claim 5, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

14. The arithmetic processing apparatus according to claim 6, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

15. The arithmetic processing apparatus according to claim 7, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

16. The arithmetic processing apparatus according to claim 8, wherein, when producing the character string which includes the plural instructions signifying performance of the series of arithmetic processes carried out by the arithmetic processing unit, the character string producing unit adds a stop instruction into the character string in response to operation of the user, and
the character string reading unit reads the character string produced by the character string producing unit, and when said character string includes the instructions with the stop instruction added, the character string reading unit makes the arithmetic processing unit carry out the arithmetic processes corresponding to the instructions, and thereafter makes the arithmetic processing unit suspend carrying out a process.

17. The arithmetic processing apparatus according to claim 16, wherein the arithmetic processing unit carries out arithmetic processes including a process of drawing a graph of a function expression in response to operation of the user, and the initial setting information storing unit stores initial setting information including a graphing condition, and when the arithmetic processing unit does not carry out an arithmetic process corresponding to the graphing condition, the character string producing unit reads the graphing condition from the initial setting information storing unit and produces a character string including the plural instructions and an instruction signifying setting of the initial setting information.
